(19) United States
(12) Patent Application Publication
(10) Pub. No.: US 2004/0069505 A1
(43) Pub. Date: Apr. 15, 2004

(54) Method and apparatus to extinguishing fire in areas beyond the reach of standard fire equipments

(76) Inventor: Joseph William Griffin, Westmont, IL (US)

Correspondence Address: JOSEPH WILLIAM GRIFFIN, P.O.BOX 81456, CHICAGO, IL, 60681, US

(21) Appl. No.: 10/270,405

(22) Filed: Oct. 15, 2002

(51) Int. Cl. A62C 2/00

(52) U.S. Cl. 169/46

(57) ABSTRACT

This invention concerns a method, an apparatus, and a process to extinguish fire in areas or in high-rise buildings where the ground or highest floor is beyond the reach of standard fire equipment such as ground/aerial ladders or hoses. The apparatus is a missile-like device that is launched above or into a targeted area. It can be guided remotely from the ground by computer. It can accept commands from and transmit information to the ground crew.

### BACKGROUND OF THE INVENTION

1. Field of the Invention

The present invention relates to unmanned aerial fire extinguisher and firefighting strategies and tactics. More specifically, my invention is primarily relates to a method, an unmanned apparatus, and a computer program product for extinguishing fires in areas beyond the reach of standard fire equipment, such as floors on high-rise buildings.

2. Description of the Prior Art

The task of high-rise firefighting is monumental. No two high-rise fires are the same and firefighters must be aware of changing conditions and variances in dealing with such structures. Constructions of high-rise buildings vary, depending on when they were designed and built. Newer high-rises have features that were absent in the earlier era. These include the use of central heating, ventilation, and air conditioning systems that move air throughout the building, and ceiling plenums that are used to return air to the system. These plenums are also used for the building's electrical and communications equipment. These buildings also contain large, uncompartmented and compartmented office spaces that allow for expanding fires. Their windows are also fixed and inoperable. The only way to vent a window is to break it—an undesirable tactic at fire operations in high-rise buildings.

Battles in today's high-rise fires are fought within, with very little help from ground ladders and outside streams. Construction features, use and knowledge of building systems such as HVAC, standpipes, elevators and communications, understanding the theories behind fire and smoke movement play an integral part of fire operations in these buildings. The fact that colorless, poisonous, odorless gases may develop and kill both firefighters and civilians cannot be emphasized enough. One of the most difficult tasks in dealing with fires in high-rise buildings is getting the resources in place quickly especially in areas where standard fire equipment such as ladders and hoses cannot reach. High-rise construction, electrical failures, poor ventilation, and improper use of HVAC systems or elevators can become hazards that can lead to death or serious injuries to both firefighters and civilians. Sep. 11, 2001 is prime example of the rapid destruction caused by the burning inferno caused by airplanes that crashed into the Twin Towers and into the Pentagon. The height of the building, the extent of the fire, the chaos that ensued, and the amount of time needed to reach the levels of the fires all led to the worst one-day tragedy the United States has ever experienced. Currently, there is no effective method at all for the firefighters to fight against the fire in the areas beyond the reach of the standard fire equipment.

What is needed then is a method, an unmanned apparatus, and a computer program product that can be deployed rapidly for extinguishing fires in areas or high rise buildings where standard fire extinguishers or equipment cannot reach.

Accordingly, it is a principal objective of my invention to provide a method, an unmanned apparatus, and a computer program product that can be deployed rapidly and is capable of extinguishing fires in areas or high-rise buildings beyond the reach of standard fire extinguishers or equipment and without risking the lives of firefighters.

It is a further objective of my invention to provide a method, an unmanned apparatus, and a computer program product that is capable of dealing with Class A fires—fires fueled by ordinary combustibles such as wood, paper plastics, etc. in an efficient way.

It is a still further objective of my invention to provide a method, an unmanned apparatus, and a computer program product that is capable of extinguishing Class B fires—fires fueled by hazardous materials such as flammable and combustible liquids in an efficient way by excluding oxygen from the fire.

It is a still further objective of my invention to provide a method, an unmanned apparatus, and a computer program product that is capable of traveling a known distance to an area or high-rise building under fire before discharging a layer of foam through a nozzle using an aqueous film forming foam (AFFF) agent and a subsurface technique to exclude oxygen from the fire.

It is a still further objective of my invention to provide a method, an unmanned apparatus, and a computer program product that is capable of controlling the direction of the device electronically during its flight.

It is a still further objective of my invention to provide a method, an unmanned apparatus, and a computer program product that is capable of delivering the proper amount of extinguishing foam agent to an area or high-rise building that is on fire beyond the reach of standard fire extinguishers or equipment and without risking the lives of firefighters.

It is a still further objective of my invention to provide a method, an unmanned apparatus, and a computer program product that is capable of using the proper application in delivering the proper amount of extinguishing foam agent to an area or high-rise building that is on fire beyond the reach of standard fire extinguishers or equipment and without risking the lives of firefighters.

It is still further objective of my invention to provide a method, an unmanned apparatus, and a computer program product that is capable of traveling a known distance to an area or high-rise building under fire before discharging a cloud of dry chemical fire retardant expelled by halon gas or carbon dioxide.

It is a still further objective of my invention to provide a method, an unmanned apparatus, and a computer program product that is capable of discharging a layer of foam through a nozzle using an aqueous film forming foam (AFFF) agent and a subsurface technique to exclude oxygen from the fire.

Other objects of my invention, as well as particular features, elements, and advantages thereof, will be elucidated in, or apparent from, the following description and the accompanying drawing figures.

### SUMMARY OF THE INVENTION

According to my present invention I have provided a method, an unmanned apparatus, and a computer program product for extinguishing fire in areas or high-rise buildings beyond the reach of standard fire extinguishers or equipment and without risking the lives of firefighters.

The present invention provides a method for the rapid deployment of an aerial fire extinguisher to extinguish fires in areas beyond the reach of standard fire equipments. This method comprises generating a request to start said aerial fire extinguisher to extinguish fires in an area beyond the reach of standard fire equipments, said aerial fire extinguisher having a central controller, a sensor, an engine, a fuel container, a fire retardant material container, said fire retardant material container containing a fire retardant material, a discharging device, and a targeting control device, said targeting control device capable of controlling said aerial fire extinguisher to fly towards said area beyond the reach of standard fire equipments; aiming said aerial fire extinguisher to said area beyond the reach of standard fire equipments; launching said aerial fire extinguisher under the control of said central controller; flying into said area beyond the reach of standard fire equipments by said aerial fire extinguisher under control of said central controller; landing at said area beyond the reach of standard fire equipments by said aerial fire extinguisher under the control of said central controller; and discharging a kind of fire retardant material carried by said aerial fire extinguisher under the control of said central controller.

The present invention also consist of an apparatus that has an engine, a delivery system, a guiding device, a locating device, an extinguishing agent container, a compressed air foam system (CAFS), a hose line with an enductor attached to it, and a payload nozzle. Also consisting of the means to discharge a extinguishing agent of dry chemicals by halon gas or carbon dioxide

The present invention further provides a computer program product having a computer readable medium having computer program logic recorded thereon for a method to control the direction of the apparatus during its flight and to control and monitor the creation and delivery of the foam agent used to extinguish the fire.

### DESCRIPTION OF THE DRAWINGS

Other features of my invention will become more evident from a consideration of the following detailed description of my patent drawings, as follows:

FIG. 1 is a structure layout of an embodiment of the aerial fire extinguisher;

FIG. 2 is shown a brief flow diagram of another embodiment for my invention of a method for the rapid deployment of an aerial fire extinguisher to extinguish fires in areas beyond the reach of standard fire equipments;

FIG. 3 is another structure of the current invention of an aerial fire extinguisher;

FIG. 4 is the procedure to fly the current invention into an area beyond the reach of standard fire equipments;

FIG. 5 is the procedure of discharging the fire retardant material carried by the aerial fire extinguisher; and

FIG. 6 is another embodiment of the current invention of an aerial fire extinguisher.

### DETAILED DESCRIPTION OF THE PREFERRED EMBODIMENT

Referring now to the drawings, my invention concerns a method, an unmanned apparatus, and a computer program product for extinguishing fire in areas or high-rise buildings beyond the reach of standard fire extinguishers or equipment and without risking the lives of firefighters.

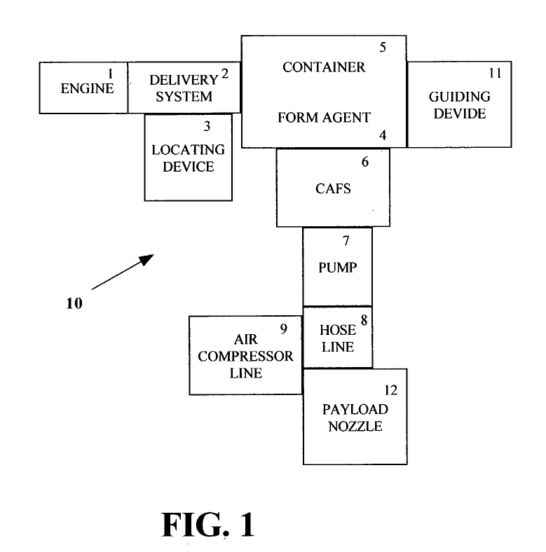

Referring now to FIG. 1, which represents said aerial fire extinguisher 10. There is an engine 1 that is used to launch and transport the apparatus toward a specified target. It contains a propulsion system that provides a driving force to move the apparatus 10 forward. For example, fuel or pressurized nitrogen thrusters can be used to blow fuel or nitrogen gas from a tank through a nozzle to move the apparatus forward. The aerial fire extinguisher 10 also has a locating device 2 used to locate a specified target. The aerial fire extinguisher 10 further has a computer-controlled delivery system 3 that controls the direction of the apparatus 10 during its flight and controls and monitors the creation and dispersion of the foam agent 4 contained by a container 5. Application of foam depends on the type of foam used, the type of incident, the topographic, and the equipment used for the application. Application rates are important and formulas are used to calculate proper application rates and to determine if the correct amount of foam is on hand to mitigate the incident. The container 5 is made up of separate compartments, where at least three ingredients—air, water, and foam concentration are stored separately. The aerial fire extinguisher 10 has a compressed air foam system (CAFS) or dual-injection system 6, which produces high-quality foam bubbles that are small and consistent in size and density. These bubbles allow the foam to stay together and provide a 25% better drain time for the foam, allowing the foam to work better and be more persistent. A foam pump 7 pumps the concentrate directly into the hose line 8, which is metered by a flow-metered microprocessor. After the foam solution is created, an air compressor line 9 injects air into the hose line 8. This creates turbulence inside the hose line 8 that creates better and more consistent foam. The CAFS 6 allows the operator to control the consistency of the foam from a runny, wet solution for quick knockdowns to a thick, dry foam for vertical exposure applications. The apparatus also has a hose with an added enductor (a device that siphons a liquid from a container into a moving stream) and can be used as an in-line proportioner to proportion the proper amount of foam concentrate for the specific type of fire. This is a critical factor when applying foam. Foam is made up of 90% or more water; the other 10% or less is the foam concentrate. The specific amount is dependent on the use of the foam blanket. For example, most manufacturers of foam require that they be proportioned at 6% for polar solvents and 3% for hydrocarbons. This means that a polar solvent fire should be extinguished with a foam blanket made up of air, 94% water, and 6% from concentrate, agitated to an effective foam blanket and applied correctly. If the product burning was a hydrocarbon, the foam blanket would be made up of air, 97% water, and 3% foam concentrate. At the end of the hose line 8 is a payload nozzle 12. The payload nozzle 12 is used to finish making the foam by adding air to it at this point. Various types of foam nozzles, regular fog nozzles, and foam generators have the ability to aspirate various quantities of air into the foam solution. The goal is to get the correct expansion ratio, that is, amount of air added to the solution. The payload nozzle 12 is also used to apply the foam agent into the burning area. It is a tapered or constricted duct, tube, pipe, or the like through which a fluid is directed and from the open end of which the fluid is discharged. It is designed to meter the fluid or to produce a desired direction, velocity or shape of discharge. Foam from nozzles is applied using one of three techniques—bank-in technique in which the foam strikes the ground before the fire rolls into the fire, bank-back or bound-off technique in which the foam is banked off a wall or other object and rolls back into the fire, and the snowflake technique in which the foam is sprayed high into the air over the fire and it floats down onto it. The aerial fire extinguisher also has a guiding device 11. This can be any automatic remote control system adopted on many weapon systems. It can include a pointing device, an infra-red or electromagnetic system for detecting the missile with respect to the pointing axis, and a computer on the ground to transform angular deviations with respect to the pointing axis and to generate remote control commands to bring the missile back to an axis parallel to the pointing axis. Also included is a system for transmission to the missile of commands generated on the ground, either through wires or electromagnetic waves.

Such guidance systems which can be used with the present invention may be found in U.S. Pat. No. 4,262,596 of Allier et al issued Apr. 21, 1981 and entitled “Overhead Attack Missile”, and in U.S. Pat. No. 3,672,607 of Stauffet al issued Jun. 27, 1972 and entitled: Sighting Telescope Infra-red Direction Finder Unit in a Teleguiding Device for Missiles” and in U.S. Pat. No. 2,856,852 of Hinman, Jr. et al issued Oct. 21, 1958 and entitled “Proximity Fuse”. The guidance system according to U.S. Pat. No. 3,672,607 can bring the missile in the direction of the target within a cylindrical corridor having an axis parallel to the pointing axis. The missile is directed to the target so that the cylindrical corridor passes above the target. Moreover the missile is provided with a proximity fuse, for instance, of a type described in U.S. Pat. No. 2,856,852 which is set to trigger the missile when the missile passes above the target. Additional guidance systems which can be used with the present invention may also be found in U.S. Pat. No. 3,406,402 of Stauffet al entitled “Optical Aiming Device” and U.S. Pat. No. 3,293,985 of Stauffet al entitled “Firing Turret for Teleguided Missiles”.

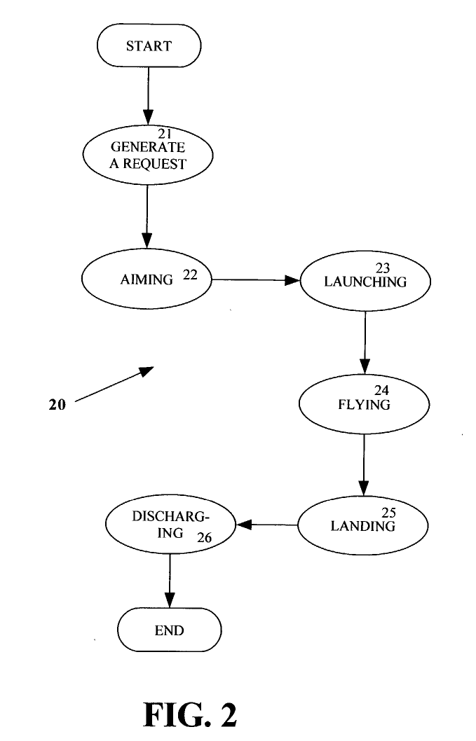

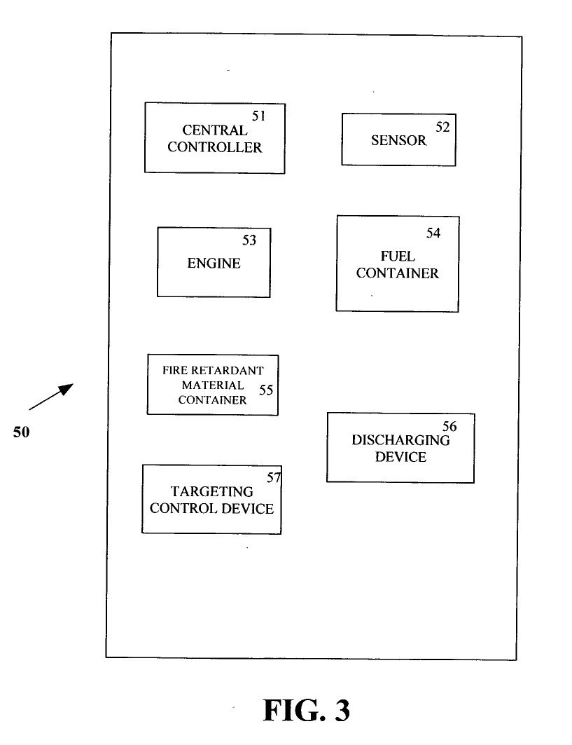

Referring now to FIG. 2, there is shown a brief flow diagram of one embodiment for my invention of a method for the rapid deployment of an aerial fire extinguisher to extinguish fires in areas beyond the reach of standard fire equipments. Said method 20 comprises several steps. The first step is to generate a request to start said aerial fire extinguisher to extinguish fires in an area beyond the reach of standard fire equipments 21. Referring now to FIG. 3, which is another structure of said aerial fire extinguisher 50. The aerial fire extinguisher 50 has a central controller 51, a sensor 52, an engine 53, a fuel container 54, a fire retardant material container 55, a discharging device 56, and a targeting control device 57. Referring now to FIG. 2 again, the second step is to aim said aerial fire extinguisher 50 to said area beyond the reach of standard fire equipments 22. The third step is to launch said aerial fire extinguisher 50 towards the area beyond the reach of standard fire equipments 23. Right after the launch, said aerial fire extinguisher 50 is under the control of said central controller 51. Said central controller 51 is controlled either by a first pre-defined computer program or by a ground station. Said ground station can be operated by a second pre-defined computer program or by an operator. The fourth step is to fly into said area 24 beyond the reach of standard fire equipments by said aerial fire extinguisher 50 under control of said central controller 51. The fifth step is to land 25 at said area beyond the reach of standard fire equipments by said aerial fire extinguisher 50 under the control of said central controller 51. The sixth step is to discharge 26 a kind of fire retardant material carried by said aerial fire extinguisher 50 under the control of said central controller 51. Said discharging can be either an explosion or at a pre-defined speed. Said pre-defined speed is defined according to the fire condition at said area beyond the reach of standard fire equipments.

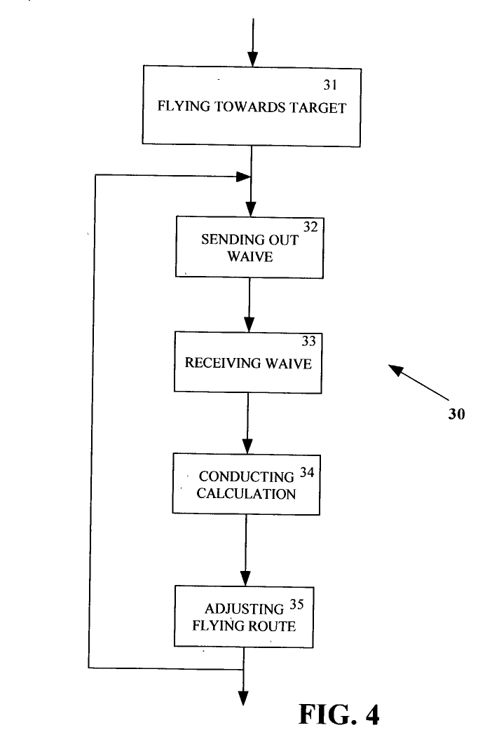

The fourth step 24 can further be separated into the following steps. Referring now to FIG. 4. The step of flying 24 into said area beyond the reach of standard fire equipments by said aerial fire extinguisher 50 under control of said central controller 51 further comprises flying towards 31 said area beyond the reach of standard fire equipments; sending out 32 a first continues signal towards said area beyond the reach of standard fire equipments by said targeting control device 57; receiving 33 a second continues signal bouncing back from said area beyond the reach of standard fire equipments by said targeting control device 57; calculating 34 said second continues signal bouncing back from said area beyond the reach of standard fire equipments by said targeting control device 57; and adjusting 35 the flying route of said aerial fire extinguisher 50 towards said area beyond the reach of standard fire equipments by said targeting control device 57.

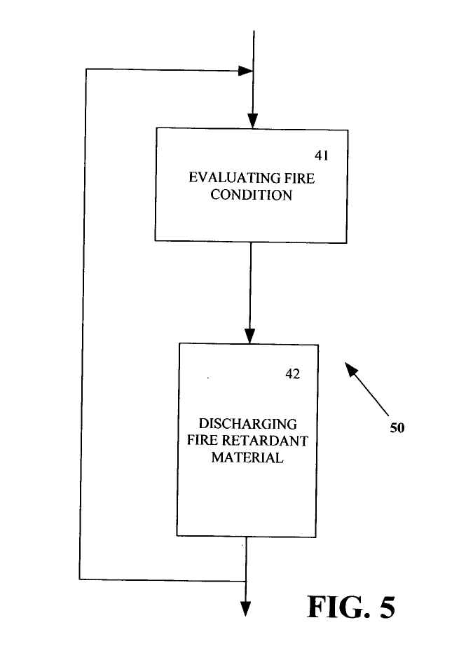

The sixth step 26 can further be separated into the following steps. Referring now to FIG. 5, wherein the step of discharging 26 a kind of fire retardant material carried by said aerial fire extinguisher 50 under the control of said central controller 51 further comprises evaluating fire conditions 41 on a continuously basis at said area beyond the reach of standard fire equipments via feedbacks from said sensor 52 to generate various results on a continuously basis; and discharging 42 a fire retardant material from said fire retardant material container 55 at a speed according to said various results.

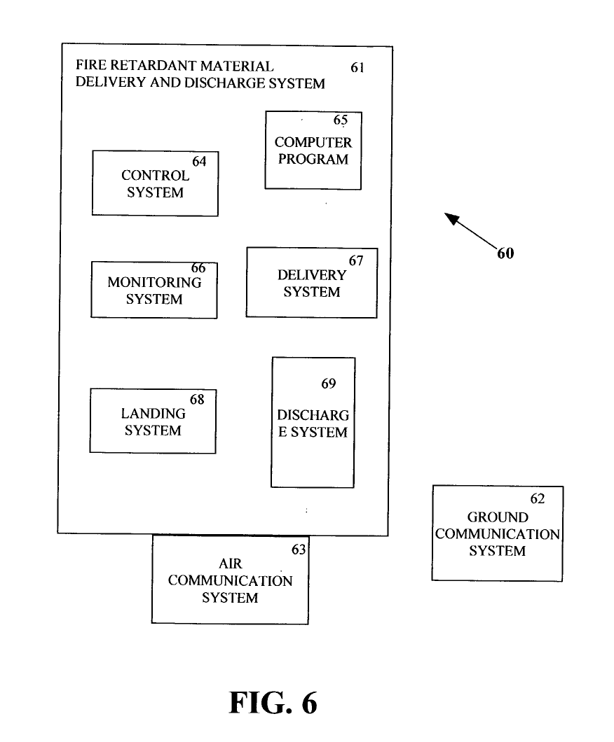

Referring now to FIG. 6, there is shown another embodiment for the present invention, an apparatus 60 for the rapid deployment of an aerial fire extinguisher 61 to extinguish fires in an area beyond the reach of standard fire equipments. Said apparatus comprises a fire retardant material delivery and discharge system 61 capable of reaching an area beyond the reach of standard fire equipments and a ground communication system 62. The fire retardant material delivery and discharge system 60 can be launched from ground, ship, air or shoulder. The fire retardant material delivery and discharge system 60 is capable of being controlled directly by an operator on ground through said ground communication system 62.

The apparatus 60 further comprises a control system 64, wherein said control system 64 is capable of controlling operation of said fire retardant material delivery and discharge system 61 according to a per-installed computer program 65. Said pre-installed computer program 65 can be a plurality of different computer programs to be used for different fire extinguishing operations. Said fire retardant material delivery and discharge system 61 further comprises a monitoring system 66, which is capable of monitoring operation of said fire retardant material delivery and discharge system 61 at said area beyond the reach of standard fire equipments. Said monitoring system 61 is capable of monitoring fire condition at said area beyond the reach of standard fire equipments even after said various foams being completely discharged from said fire retardant material delivery and discharge system 60. Said monitoring system 66 is also capable of providing information to said control system 64 to effectively control operation of said fire retardant material delivery and discharge system 61 and to said air communication system 63 to communication to said ground communication system 62. Said fire retardant material delivery and discharge system 61 further comprises a delivery system 67, which is capable of delivering said fire retardant material delivery and discharge system 61 to said area beyond the reach of standard fire equipments. Said fire retardant material delivery and discharge system 61 further comprises a landing system 68, which is capable of landing said fire retardant material delivery and discharge system 61 on said area beyond the reach of standard fire equipments. Said fire retardant material delivery and discharge system 61 further comprises a discharge system 69, which contains a plurality of fire retardant materials. Each of said plurality of said fire retardant materials has different heat resistance abilities. Said discharge system 69 is capable of mixing such plurality of fire retardant materials to generate various foams. Said various foams can be discharged at various pre-set speeds under the control of said control system 64 to extinguish different kinds of fire.

Said fire retardant material delivery and discharge system 61 further comprises an air communication system 63, which is controlled and operated by said control system 64. Said air communication system 63 is capable of sending out real-time information about fire and environment at said area beyond the reach of standard fire equipments and receiving a commend to instruct said control device 64 to operate said monitoring system 66, said delivery system 67, said landing system 68, and said discharge system 69. Said real-time information includes direction, distance traveled and location of said fire retardant material delivery and discharge system 61.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A method for the rapid deployment of an aerial fire extinguisher to extinguish fires in areas beyond the reach of standard fire equipments, said method comprising:
generating a request to start said aerial fire extinguisher to extinguish fires in an area beyond the reach of standard fire equipments, said aerial fire extinguisher having a central controller, said central controller being a plurality of controllers, a sensor, said sensor being a plurality of sensors located at various places of said aerial fire extinguisher, an engine, said engine being a plurality of engines, a fuel container, said fuel containers being a plurality of fuel containers, a fire retardant material container, said fire retardant material container containing a fire retardant material, said fire retardant material being a plurality of materials, a discharging device, said discharging device capable of discharging said fire retardant material at various speeds, and a targeting control device, said targeting control device capable of controlling said aerial fire extinguisher to fly towards said area beyond the reach of standard fire equipments;
aiming said aerial fire extinguisher to said area beyond the reach of standard fire equipments;
launching said aerial fire extinguisher under the control of said central controller, said central controller being controlled either by a first pre-defined computer program or by a ground station, said ground station being operated by a second pre-defined computer program or by an operator;
flying into said area beyond the reach of standard fire equipments by said aerial fire extinguisher under control of said central controller;
landing at said area beyond the reach of standard fire equipments by said aerial fire extinguisher under the control of said central controller; and
discharging a kind of fire retardant material carried by said aerial fire extinguisher under the control of said central controller, said discharging being either an explosion or at a pre-defined speed, said pre-defined speed being defined according to the fire condition at said area beyond the reach of standard fire equipments.

2. The method of claim 1, wherein the step of flying into said area beyond the reach of standard fire equipments by said aerial fire extinguisher under control of said central controller further comprises:
flying towards said area beyond the reach of standard fire equipments;
sending out a first continues signal towards said area beyond the reach of standard fire equipments by said targeting control device;
receiving a second continues signal bouncing back from said area beyond the reach of standard fire equipments by said targeting control device;
calculating said second continues signal bouncing back from said area beyond the reach of standard fire equipments by said targeting control device; and
adjusting the flying route of said aerial fire extinguisher towards said area beyond the reach of standard fire equipments by said targeting control device.

3. The method of claim 1, wherein the step of discharging a kind of fire retardant material carried by said aerial fire extinguisher under the control of said central controller further comprises:
evaluating fire conditions on a continuously basis at said area beyond the reach of standard fire equipments via feedbacks from said sensor to generate various results on a continuously basis; and
discharging a fire retardant material from said fire retardant material container at a speed according to said various results.

4. A method for the rapid deployment of an aerial fire extinguisher to extinguish fires in areas beyond the reach of standard fire equipments, said method comprising:
generating a request to start said aerial fire extinguisher to extinguish fires in an area beyond the reach of standard fire equipments, said aerial fire extinguisher having a central controller, a sensor, an engine, a fuel container, a fire retardant material container, said fire retardant material container containing a fire retardant material, a discharging device, and a targeting control device, said targeting control device capable of controlling said aerial fire extinguisher to fly towards said area beyond the reach of standard fire equipments;
aiming said aerial fire extinguisher to said area beyond the reach of standard fire equipments;
launching said aerial fire extinguisher under the control of said central controller;
flying into said area beyond the reach of standard fire equipments by said aerial fire extinguisher under control of said central controller;
landing at said area beyond the reach of standard fire equipments by said aerial fire extinguisher under the control of said central controller; and
discharging a kind of fire retardant material carried by said aerial fire extinguisher under the control of said central controller.

5. The method of claim 4, wherein said central controller can be either one single controller or a plurality of controllers, each of said plurality of controllers capable of performing its own duties in controlling said aerial fire extinguisher to fly to and discharging said kind of fire retardant material at said area beyond the reach of standard fire equipments.

6. The method of claim 4, wherein said sensor can be either one single sensor or a plurality of sensors located at various places of said aerial fire extinguisher, said plurality of sensors being either identical or different from each other according to the need of said aerial fire extinguisher.

7. The method of claim 4, wherein said engine can be either one single engine or a plurality of engines, said engine capable of providing needed power for said aerial fire extinguisher and discharging said fire retardant material by said aerial fire extinguisher.

8. The method of claim 4, wherein said fuel container can be either one singer fuel container or a plurality of fuel containers, said plurality of fuel containers being either identical or different from each other according to the need of said aerial fire extinguisher.

9. The method of claim 4, wherein said fire retardant material can be either one single fire retardant material or a plurality of different fire retardant materials.

10. The method of claim 4, wherein said discharging device can be either, one single discharging device or a plurality of discharging devices, said discharging device capable of discharging said fire retardant material at various speeds controlled by said central controller.

11. The method of claim 4, wherein the step of flying into said area beyond the reach of standard fire equipments by said aerial fire extinguisher under control of said pre-defined computer program further comprises:
flying towards said area beyond the reach of standard fire equipments;
sending out a first continues signal towards said area beyond the reach of standard fire equipments by said targeting control device;
receiving a second continues signal bouncing back from said area beyond the reach of standard fire equipments by said targeting control device;
calculating said second continues signal bouncing back from said area beyond the reach of standard fire equipments by said targeting control device adjusting the flying route of said aerial fire extinguisher towards said area beyond the reach of standard fire equipments by said targeting control device.

12. The method of claim 4, wherein the step of discharging a kind of fire retardant material carried by said aerial fire extinguisher under the control of said central controller further comprises:
evaluating fire conditions on a continuously basis at said area beyond the reach of standard fire equipments via feedbacks from said sensor to generate various results on a continuously basis; and
discharging a fire retardant material from said fire retardant material container at a speed according to said various results.

13. An apparatus for the rapid deployment of an aerial fire extinguisher to extinguish fires in areas beyond the reach of standard fire equipments, said apparatus comprising:
means for generating a request to start said aerial fire extinguisher to extinguish fires in an area beyond the reach of standard fire equipments, said aerial fire extinguisher having a central controller, said central controller being a plurality of controllers, a sensor, said sensor being a plurality of sensors located at various places of said aerial fire extinguisher, an engine, said engine being a plurality of engines, a fuel container, said fuel containers being a plurality of fuel containers, a fire retardant material container, said fire retardant material container containing a fire retardant material, said fire retardant material being a plurality of materials, a discharging device, said discharging device capable of discharging said fire retardant material at various speeds, and a targeting control device, said targeting control device capable of controlling said aerial fire extinguisher to fly towards said area beyond the reach of standard fire equipments;
means for aiming said aerial fire extinguisher to said area beyond the reach of standard fire equipments;
means for launching said aerial fire extinguisher under the control of said central controller, said central controller being controlled either by a first pre-defined computer program or by a ground station, said ground station being operated by a second pre-defined computer program or by an operator;
means for flying into said area beyond the reach of standard fire equipments by said aerial fire extinguisher under control of said central controller;
means for landing at said area beyond the reach of standard fire equipments by said aerial fire extinguisher under the control of said central controller; and
means for discharging a kind of fire retardant material carried by said aerial fire extinguisher under the control of said central controller, said discharging being either an explosion or at a pre-defined speed, said pre-defined speed being defined according to the fire condition at said area beyond the reach of standard fire equipments.

14. The apparatus of claim 13, wherein the means for flying into said area beyond the reach of standard fire equipments by said aerial fire extinguisher under control of said central controller further comprises:
means for flying towards said area beyond the reach of standard fire equipments;
means for sending out a first continues signal towards said area beyond the reach of standard fire equipments by said targeting control device;
means for receiving a second continues signal bouncing back from said area beyond the reach of standard fire equipments by said targeting control device;
means for calculating said second continues signal bouncing back from said area beyond the reach of standard fire equipments by said targeting control device; and
means for adjusting the flying route of said aerial fire extinguisher towards said area beyond the reach of standard fire equipments by said targeting control device.

15. The apparatus of claim 13, wherein the means for discharging a kind of fire retardant material carried by said aerial fire extinguisher under the control of said central controller further comprises:
means for evaluating fire conditions on a continuously basis at said area beyond the reach of standard fire equipments via feedbacks from said sensor to generate various results on a continuously basis; and
means for discharging a fire retardant material from said fire retardant material container at a speed according to said various results.

16. An apparatus for the rapid deployment of an aerial fire extinguisher to extinguish fires in areas beyond the reach of standard fire equipments, said apparatus comprising:
means for generating a request to start said aerial fire extinguisher to extinguish fires in an area beyond the reach of standard fire equipments, said aerial fire extinguisher having a central controller, a sensor, an engine, a fuel container, a fire retardant material container, said fire retardant material container containing a fire retardant material, a discharging device, and a targeting control device, said targeting control device capable of controlling said aerial fire extinguisher to fly towards said area beyond the reach of standard fire equipments;
means for aiming said aerial fire extinguisher to said area beyond the reach of standard fire equipments;
means for launching said aerial fire extinguisher under the control of said central controller;
means for flying into said area beyond the reach of standard fire equipments by said aerial fire extinguisher under control of said central controller;
means for landing at said area beyond the reach of standard fire equipments by said aerial fire extinguisher under the control of said central controller; and
means for discharging a kind of fire retardant material carried by said aerial fire extinguisher under the control of said central controller.

17. The apparatus of claim 16, wherein said central controller can be either one single controller or a plurality of controllers, each of said plurality of controllers capable of performing its own duties in controlling said aerial fire extinguisher to fly to and discharging said kind of fire retardant material at said area beyond the reach of standard fire equipments.

18. The apparatus of claim 16, wherein said sensor can be either one single sensor or a plurality of sensors located at various places of said aerial fire extinguisher, said plurality of sensors being either identical or different from each other according to the need of said aerial fire extinguisher.

19. The apparatus of claim 16, wherein said engine can be either one single engine or a plurality of engines, said engine capable of providing needed power for said aerial fire extinguisher and discharging said fire retardant material by said aerial fire extinguisher.

20. The apparatus of claim 16, wherein said fuel container can be either one single fuel container or a plurality of fuel containers, said plurality of fuel containers being either identical or different from each other according to the need of said aerial fire extinguisher.

21. The apparatus of claim 16, wherein said fire retardant material can be either one single fire retardant material or a plurality of different fire retardant materials.

22. The apparatus of claim 16, wherein said discharging device can be either one single discharging device or a plurality of discharging devices, said discharging device capable of discharging said fire retardant material at various speeds controlled by said central controller.

23. The apparatus of claim 16, wherein the means for flying into said area beyond the reach of standard fire equipments by said aerial fire extinguisher under control of said pre-defined computer program further comprises:
means for flying towards said area beyond the reach of standard fire equipments;
means for sending out a first continues signal towards said area beyond the reach of standard fire equipments by said targeting control device;
means for receiving a second continues signal bouncing back from said area beyond the reach of standard fire equipments by said targeting control device;
means for calculating said second continues signal bouncing back from said area beyond the reach of standard fire equipments by said targeting control device
means for adjusting the flying route of said aerial fire extinguisher towards said area beyond the reach of standard fire equipments by said targeting control device.

24. The apparatus of claim 16, wherein the means for discharging a kind of fire retardant material carried by said aerial fire extinguisher under the control of said central controller further comprises:
means for evaluating fire conditions on a continuously basis at said area beyond the reach of standard fire equipments via feedbacks from said sensor to generate various results on a continuously basis; and
means for discharging a fire retardant material from said fire retardant material container at a speed according to said various results.

25. A computer program product having a computer readable medium having computer program logic recorded thereon for a method for the rapid deployment of an aerial fire extinguisher to extinguish fires in areas beyond the reach of standard fire equipments, said computer program product comprising:
computer readable means for generating a request to start said aerial fire extinguisher to extinguish fires in an area beyond the reach of standard fire equipments, said aerial fire extinguisher having a central controller, said central controller being a plurality of controllers, a sensor, said sensor being a plurality of sensors located at various places of said aerial fire extinguisher, an engine, said engine being a plurality of engines, a fuel container, said fuel containers being a plurality of fuel containers, a fire retardant material container, said fire retardant material container containing a fire retardant material, said fire retardant material being a plurality of materials, a discharging device, said discharging device capable of discharging said fire retardant material at various speeds, and a targeting control device, said targeting control device capable of controlling said aerial fire extinguisher to fly towards said area beyond the reach of standard fire equipments;
computer readable means for aiming said aerial fire extinguisher to said area beyond the reach of standard fire equipments;
computer readable means for launching said aerial fire extinguisher under the control of said central controller, said central controller being controlled either by a first pre-defined computer program or by a ground station, said ground station being operated by a second pre-defined computer program or by an operator;
computer readable means for flying into said area beyond the reach of standard fire equipments by said aerial fire extinguisher under control of said central controller;
computer readable means for landing at said area beyond the reach of standard fire equipments by said aerial fire extinguisher under the control of said central controller; and
computer readable means for discharging a kind of fire retardant material carried by said aerial fire extinguisher under the control of said central controller, said discharging being either an explosion or at a pre-defined speed, said pre-defined speed being defined according to the fire condition at said area beyond the reach of standard fire equipments.

26. The computer program product of claim 25, wherein the computer readable means for flying into said area beyond the reach of standard fire equipments by said aerial fire extinguisher under control of said central controller further comprises:
computer readable means for flying towards said area beyond the reach of standard fire equipments;
computer readable means for sending out a first continues signal towards said area beyond the reach of standard fire equipments by said targeting control device;
computer readable means for receiving a second continues signal bouncing back from said area beyond the reach of standard fire equipments by said targeting control device;
computer readable means for calculating said second continues signal bouncing back from said area beyond the reach of standard fire equipments by said targeting control device; and
computer readable means for adjusting the flying route of said aerial fire extinguisher towards said area beyond the reach of standard fire equipments by said targeting control device.

27. The computer program product of claim 25, wherein the computer readable means for discharging a kind of fire retardant material carried by said aerial fire extinguisher under the control of said central controller further comprises:
computer readable means for evaluating fire conditions on a continuously basis at said area beyond the reach of standard fire equipments via feedbacks from said sensor to generate various results on a continuously basis; and
computer readable means for discharging a fire retardant material from said fire retardant material container at a speed according to said various results.

28. A computer program product having a computer readable medium having computer program logic recorded thereon for a method for the rapid deployment of an aerial fire extinguisher to extinguish fires in areas beyond the reach of standard fire equipments, said computer program product comprising:
computer readable means for generating a request to start said aerial fire extinguisher to extinguish fires in an area beyond the reach of standard fire equipments, said aerial fire extinguisher having a central controller, a sensor, an engine, a fuel container, a fire retardant material container, said fire retardant material container containing a fire retardant material, a discharging device, and a targeting control device, said targeting control device capable of controlling said aerial fire extinguisher to fly towards said area beyond the reach of standard fire equipments;
computer readable means for aiming said aerial fire extinguisher to said area beyond the reach of standard fire equipments;
computer readable means for launching said aerial fire extinguisher under the control of said central controller;
computer readable means for flying into said area beyond the reach of standard fire equipments by said aerial fire extinguisher under control of said central controller;
computer readable means for landing at said area beyond the reach of standard fire equipments by said aerial fire extinguisher under the control of said central controller; and
computer readable means for discharging a kind of fire retardant material carried by said aerial fire extinguisher under the control of said central controller.

29. The computer program product of claim 28, wherein said central controller can be either one single controller or a plurality of controllers, each of said plurality of controllers capable of performing its own duties in controlling said aerial fire extinguisher to fly to and discharging said kind of fire retardant material at said area beyond the reach of standard fire equipments.

30. The computer program product of claim 28, wherein said sensor can be either one single sensor or a plurality of sensors located at various places of said aerial fire extinguisher, said plurality of sensors being either identical or different from each other according to the need of said aerial fire extinguisher.

31. The computer program product of claim 28, wherein said engine can be either one single engine or a plurality of engines, said engine capable of providing needed power for said aerial fire extinguisher and discharging said fire retardant material by said aerial fire extinguisher.

32. The computer program product of claim 28, wherein said fuel container can be either one singer fuel container or a plurality of fuel containers, said plurality of fuel containers being either identical or different from each other according to the need of said aerial fire extinguisher.

33. The computer program product of claim 28, wherein said fire retardant material can be either one single fire retardant material or a plurality of different fire retardant materials.

34. The computer program product of claim 28, wherein said discharging device can be either one single discharging device or a plurality of discharging devices, said discharging device capable of discharging said fire retardant material at various speeds controlled by said central controller.

35. The computer program product of claim 28, wherein the step of flying into said area beyond the reach of standard fire equipments by said aerial fire extinguisher under control of said pre-defined computer program further comprises:
flying towards said area beyond the reach of standard fire equipments;
sending out a first continues signal towards said area beyond the reach of standard fire equipments by said targeting control device;
receiving a second continues signal bouncing back from said area beyond the reach of standard fire equipments by said targeting control device;
calculating said second continues signal bouncing back from said area beyond the reach of standard fire equipments by said targeting control device adjusting the flying route of said aerial fire extinguisher towards said area beyond the reach of standard fire equipments by said targeting control device.

36. The computer program product of claim 28, wherein the computer readable means for discharging a kind of fire retardant material carried by said aerial fire extinguisher under the control of said central controller further comprises:
computer readable means for evaluating fire conditions on a continuously basis at said area beyond the reach of standard fire equipments via feedbacks from said sensor to generate various results on a continuously basis; and
computer readable means for discharging a fire retardant material from said fire retardant material container at a speed according to said various results.

37. An apparatus for the rapid deployment of an aerial fire extinguisher to extinguish fires in an area beyond the reach of standard fire equipments, said apparatus comprising:
a fire retardant material delivery and discharge system capable of reaching an area beyond the reach of standard fire equipments, said fire retardant material delivery and discharge system having a control system, said control system capable of controlling operation of said fire retardant material delivery and discharge system, a monitoring system, said monitoring system capable of monitoring operation of said fire retardant material delivery and discharge system and said area beyond the reach of standard fire equipments, a delivery system, said delivery system capable of delivering said fire retardant material delivery and discharge system to said area beyond the reach of standard fire equipments, a landing system, said landing system capable of landing said fire retardant material delivery and discharge system on said area beyond the reach of standard fire equipments, and a discharge system, said discharge system containing a plurality of fire retardant materials, each of said plurality of said fire retardant materials having different heat resistance abilities, said discharge system capable of mixing such plurality of fire retardant materials to generate various foams, said various foams being discharged at various pre-set speeds under the control of said control device to extinguish different kinds of fire;
an air communication system, said air communication system being controlled and operated by said control system, said air communication system being capable of sending out real-time information about fire and environment at said area beyond the reach of standard fire equipments and receiving a commend to instruct said control device to operate said monitoring system, said delivery system, said landing system, and said discharge system, said real-time information including direction, distance traveled and location of said fire retardant material delivery and discharge system; and
a ground communication system, said second communication system being capable of receiving information from said air communication system and sending said commend to said air communication system.

38. The apparatus of claim 37, wherein said fire retardant material delivery and discharge system can be launched from ground, ship, air or shoulder.

39. The apparatus of claim 37, wherein said fire retardant material delivery and discharge system is capable of being controlled directly by an operator on ground through said ground communication system, said air communication system and said control system.

40. The apparatus of claim 37, wherein said fire retardant material delivery and discharge system is capable of monitoring fire condition at said area beyond the reach of standard fire equipments even after said various foams being completely discharged.

41. An apparatus for the rapid deployment of an aerial fire extinguisher to extinguish fires in an area beyond the reach of standard fire equipments, said apparatus comprising:
a fire retardant material delivery and discharge system capable of reaching an area beyond the reach of standard fire equipments, said fire retardant material delivery and discharge system having a control system, a monitoring system, a delivery system, a landing system, and a discharge system;
an air communication system; and
a ground communication system.

42. The apparatus of claim 41, wherein said control system is capable of controlling operation of said fire retardant material delivery and discharge system according to a per-installed computer program, said pre-installed computer program being a plurality of different computer programs to be used for different fire extinguishing operations.

43. The apparatus of claim 41, wherein said monitoring system is capable of monitoring operation of said fire retardant material delivery and discharge system and said area beyond the reach of standard fire equipments.

44. The apparatus of claim 41, wherein said monitoring system is capable of providing information to said control system to effectively control operation of said fire retardant material delivery and discharge system and to said air communication system to communication to said ground communication system.

45. The apparatus of claim 41, wherein said delivery system is capable of delivering said fire retardant material delivery and discharge system to said area beyond the reach of standard fire equipments.

46. The apparatus of claim 41, wherein said landing system is capable of landing said fire retardant material delivery and discharge system on said area beyond the reach of standard fire equipments.

47. The apparatus of claim 41, wherein said discharge system contains a plurality of fire retardant materials, each of said plurality of said fire retardant materials having different heat resistance abilities, said discharge system capable of mixing such plurality of fire retardant materials to generate various foams, said various foams being discharged at various pre-set speeds under the control of said control device to extinguish different kinds of fire.

48. The apparatus of claim 41, wherein said air communication system is controlled and operated by said control system, said air communication system being capable of sending out real-time information about fire and environment at said area beyond the reach of standard fire equipments and receiving a commend to instruct said control device to operate said monitoring system, said delivery system, said landing system, and said discharge system, said real-time information including direction, distance traveled and location of said fire retardant material delivery and discharge system.

49. The apparatus of claim 41, wherein said second communication system is capable of receiving information from said air communication system and sending said commend to said air communication system.

50. The apparatus of claim 41, wherein said fire retardant material delivery and discharge system can be launched from ground, ship, air or shoulder.

51. The apparatus of claim 41, wherein said fire retardant material delivery and discharge system is capable of being controlled directly by an operator on ground through said ground communication system, said air communication system and said control system.

52. The apparatus of claim 41, wherein said monitoring system is capable of monitoring fire condition at said area beyond the reach of standard fire equipments even after said various foams being completely discharged.

53. An apparatus for the rapid deployment of an aerial fire extinguisher to extinguish fires in an area beyond the reach of standard fire equipments, said apparatus comprising:
a fire retardant material delivery and discharge system capable of reaching an area beyond the reach of standard fire equipments; and
a ground communication system.

54. The apparatus of claim 53, wherein said fire retardant material delivery and discharge system can be launched from ground, ship, air or shoulder.

55. The apparatus of claim 54, wherein said fire retardant material delivery and discharge system is capable of being controlled directly by an operator on ground through said ground communication system.

56. The apparatus of claim 55 further comprises a control system, said control system is capable of controlling operation of said fire retardant material delivery and discharge system according to a per-installed computer program, said pre-installed computer program being a plurality of different computer programs to be used for different fire extinguishing operations.

57. The apparatus of claim 56, wherein said fire retardant material delivery and discharge system further comprises a monitoring system, said monitoring system being capable of monitoring operation of said fire retardant material delivery and discharge system at said area beyond the reach of standard fire equipments.

58. The apparatus of claim 57, wherein said monitoring system is capable of monitoring fire condition at said area beyond the reach of standard fire equipments even after said various foams being completely discharged from said fire retardant material delivery and discharge system.

59. The apparatus of claim 58, wherein said monitoring system is capable of providing information to said control system to effectively control operation of said fire retardant material delivery and discharge system and to said air communication system to communication to said ground communication system.

60. The apparatus of claim 59, wherein said fire retardant material delivery and discharge system further comprises a delivery system, said delivery system being capable of delivering said fire retardant material delivery and discharge system to said area beyond the reach of standard fire equipments.

61. The apparatus of claim 60, wherein said fire retardant material delivery and discharge system further comprises a landing system, said landing system being capable of landing said fire retardant material delivery and discharge system on said area beyond the reach of standard fire equipments.

62. The apparatus of claim 61, wherein said fire retardant material delivery and discharge system further comprises a discharge system, said discharge system containing a plurality of fire retardant materials, each of said plurality of said fire retardant materials having different heat resistance abilities, said discharge system capable of mixing such plurality of fire retardant materials to generate various foams, said various foams being discharged at various pre-set speeds under the control of said control system to extinguish different kinds of fire.

63. The apparatus of claim 62, wherein said fire retardant material delivery and discharge system further comprises an air communication system, said air communication system being controlled and operated by said control system, said air communication system being capable of sending out real-time information about fire and environment at said area beyond the reach of standard fire equipments and receiving a commend to instruct said control device to operate said monitoring system, said delivery system, said landing system, and said discharge system, said real-time information including direction, distance traveled and location of said fire retardant material delivery and discharge system.

64. The apparatus of claim 63, wherein said fire retardant material delivery and discharge system further comprises a second communication system, said second communication system being capable of receiving information from said air communication system and sending said commend to said air communication system.

65. A method for the rapid deployment of an aerial fire extinguisher to extinguish fires in an area beyond the reach of standard fire equipments, said method comprising:
receiving a request to start said aerial fire extinguisher to extinguish fires in an area beyond the reach of standard fire equipments;
igniting a delivery system of said aerial fire extinguisher;
launching said aerial fire extinguisher towards said area beyond the reach of standard fire equipments;
monitoring direction and distance towards said area beyond the reach of standard fire equipments and distance traveled and location of said aerial fire extinguisher by a monitoring system of said aerial fire extinguisher;
landing said aerial fire extinguisher at said area beyond the reach of standard fire equipments, said landing being either a complete stop of said aerial fire extinguisher or a significant reduction in speed of said aerial fire extinguisher;
monitoring fire condition at said area beyond the reach of standard fire equipments;
generating a result from said monitoring;
generating a combination of said fire retardant material according to said result;
choosing a discharging method to discharge said fire retardant material according to said result; and
discharging said fire retardant material according to said discharging method.

66. The method of claim 65, wherein said fire retardant material includes water, air and a foam agent, said foam concentrate being a plurality of different foam concentrates, each of such plurality of different foam concentrates being mixed with said water and said air to create different types of foams, each of said different type of foams having different heat resistance ability.

67. The method of claim 65, wherein the step of generating a result from said monitoring further comprises communicating said result to a ground control unit, said ground control unit capable of providing further instructions to control operation of said aerial fire extinguisher at said area beyond the reach of standard fire equipments.

68. An apparatus for the rapid deployment of an aerial fire extinguisher to extinguish fires in an area beyond the reach of standard fire equipments, said apparatus comprising:
means for receiving a request to start said aerial fire extinguisher to extinguish fires in an area beyond the reach of standard fire equipments;
means for igniting a delivery system of said aerial fire extinguisher;
means for launching said aerial fire extinguisher towards said area beyond the reach of standard fire equipments;
means for monitoring direction and distance towards said area beyond the reach of standard fire equipments and distance traveled and location of said aerial fire extinguisher by a monitoring system of said aerial fire extinguisher;
means for landing said aerial fire extinguisher at said area beyond the reach of standard fire equipments, said landing being either a complete stop of said aerial fire extinguisher or a significant reduction in speed of said aerial fire extinguisher;
means for monitoring fire condition at said area beyond the reach of standard fire equipments;
means for generating a result from said monitoring;
means for generating a combination of said fire retardant material according to said result;
means for choosing a discharging method to discharge said fire retardant material according to said result; and
means for discharging said fire retardant material according to said discharging method.

69. The apparatus of claim 68, wherein said fire retardant material includes water, air and a foam agent, said foam concentrate being a plurality of different foam concentrates, each of such plurality of different foam concentrates being mixed with said water and said air to create different types of foams, each of said different type of foams having different heat resistance ability.

70. The method of claim 68, wherein said means for generating a result from said monitoring further comprises means for communicating said result to a ground control unit, said ground control unit capable of providing further instructions to control operation of said aerial fire extinguisher at said area beyond the reach of standard fire equipments.

71. A computer program product having a computer readable medium having computer program logic recorded thereon for a method for the rapid deployment of an aerial fire extinguisher to extinguish fires in an area beyond the reach of standard fire equipments, said computer program product comprising:
computer readable means for receiving a request to start said aerial fire extinguisher to extinguish fires in an area beyond the reach of standard fire equipments;
computer readable means for igniting a delivery system of said aerial fire extinguisher;
computer readable means for launching said aerial fire extinguisher towards said area beyond the reach of standard fire equipments;
computer readable means for monitoring direction and distance towards said area beyond the reach of standard fire equipments and distance traveled and location of said aerial fire extinguisher by a monitoring system of said aerial fire extinguisher;
computer readable means for landing said aerial fire extinguisher at said area beyond the reach of standard fire equipments, said landing being either a complete stop of said aerial fire extinguisher or a significant reduction in speed of said aerial fire extinguisher;
computer readable means for monitoring fire condition at said area beyond the reach of standard fire equipments;
computer readable means for generating a result from said monitoring;
computer readable means for generating a combination of said fire retardant material according to said result;
computer readable means for choosing a discharging method to discharge said fire retardant material according to said result; and
computer readable means for discharging said fire retardant material according to said discharging method.

72. The computer program product of claim 71, wherein said fire retardant material includes water, air and a foam agent, said foam concentrate being a plurality of different foam concentrates, each of such plurality of different foam concentrates being mixed with said water and said air to create different types of foams, each of said different type of foams having different heat resistance ability.

73. The computer program product of claim 71 further comprises computer readable means for communicating said result to a ground control unit, said ground control unit capable of providing further instructions to control operation of said aerial fire extinguisher at said area beyond the reach of standard fire equipments.
